(19) United States
(12) Patent Application Publication
(10) Pub. No.: US 2020/0141703 A1
(43) Pub. Date: May 7, 2020

(54) Passive Laser Protective Coatings

(71) Applicant: Shiva Science & Technology Group LLC, Lewisburg, PA (US)

(72) Inventor: Anthony David Bressi, Danville, PA (US)

(73) Assignee: Shiva Science & Technology Group LLC, Lewisburg, PA (US)

(21) Appl. No.: 16/377,171

(22) Filed: Apr. 6, 2019

Related U.S. Application Data
(60) Provisional application No. 62/654,478, filed on Apr. 8, 2018.

(51) Int. Cl. F41H 11/00; G02B 5/128

(52) U.S. Cl. CPC F41H 11/00; F41H 13/0062; G02B 5/128

(57) ABSTRACT

Disclosed are coatings applied to a surface, which upon irradiation by a laser beam, results in specular reflection of a portion of the incident laser beam upon said surface, back towards the source of said beam. Furthermore, the coating may also result in diffuse reflection of another portion of said laser beam away from said surface. This reduces the absorption rate of the incident laser energy by the surface, thus lengthening the amount of time, known as the engagement time, needed to compromise the structural integrity of the underlying material. The laser light reflected back towards the source may also interfere with the sensors used by the laser system to focus and/or track the target, an effect known as “dazzling.” This “dazzling” effect may also serve to lengthen the necessary engagement time needed to inflict structural damage on the target. By application of the disclosed coatings, the engagement time may be lengthened to the point where the target would survive the encounter with the laser beam. Additionally, these coatings may reduce the effectiveness and/or effective range of some target designation systems by reflecting a significant portion of the incident laser radiation back towards the laser designator, thus making it unavailable for scattering and sensing by the sensors aboard an incoming laser-guided projectile, bomb, missile, or other laser-guided device. Furthermore, enough laser light may be reflected back to dazzle or blind the sensors aboard an incoming laser-guided weapon with a trajectory near illumination beam axis.

### CROSS-REFERENCE TO RELATED APPLICATIONS

This application claims the priority benefit under 35 USC 119(e) from U.S. Provisional Application No. 62/654,478, “Passive Laser Protective Coatings,” filed on the 8′ day of April, 2018 and which is incorporated herein in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### FIELD OF THE INVENTION

The present invention relates to defense, specifically protection of potential targets from laser beam directed energy weapons along with laser-guided weapons and target designation systems.

### BACKGROUND OF THE INVENTION

Laser-based directed energy weapon systems are becoming increasingly popular within the defense industry. The current models are designed primarily to use high-power lasers to inflict enough damage to an aerial vehicle or projectile to cause loss of controlled flight or even to ignite fuel or explosives aboard. They have been successfully tested against a variety of aerial targets including aerial drones, artillery rockets, and mortar bombs.

These weapon systems normally utilize a source for the high power laser beam or beams coupled with an adaptive optics system to enable focusing of the beam or beams on or near the target. In order to properly adjust the focus, said adaptive optics system utilizes a laser itself to determine the aberration caused by the atmosphere between the weapon system itself and the target. The closer the emitter and sensor for this purpose is to the beam shaping optics of the system, usually a mirror, the better the accuracy of the focus with the result of higher energy transfer to the target rates. Since higher energy transfer to the target rates correlate to reduced target engagement times, current weapon systems place the emitter and sensor for the adaptive optics system on the same platform in close proximity to beam shaping optics.

Even with the development of such laser-based directed energy weapons, the principal use of lasers in military weaponry is for target-designation and weapon guidance. In these systems a laser beam is used to illuminate a spot on the target while sensors on the projectile, bomb, or missile are used to detect the reflected laser light and guide the weapon to the target.

The sensors used to detect the reflected laser light for both weapon guidance and to control adaptive optics may be blinded or “dazzled” if too much light in the proper wavelength range falls upon their light-sensitive components. This effectively disables them, at least for the time period they are so illuminated.

Some defensive systems actively use laser beams of appropriate wavelength to blind or dazzle the optical guidance sensors of weapons such as missiles.

Retroreflectors are objects which reflects light back towards it source with minimal scattering. A common form of retroreflector is a sphere of glass that is half-coated with a metallic surface to improve back-side reflection. This speherical type of retroreflector (with and without the metallic coating) is commonly encountered in admixture with paints used for marking road surfaces. Further applications of this type of retroreflector are in signs, clothing, and retroreflective tapes.

### BRIEF SUMMARY OF THE INVENTION

The present invention advantageously utilizes retroreflective coatings applied to the surface of a projectile, vehicle, or other object to improve its survivability against laser-based directed energy weapons. These coatings also may be used to increase survivability against weapons that utilize a laser designation and guidance system.

The coatings improves survivability against laser-based directed energy weapons through several mechanisms. One mechanism is that they reflect away a portion of the incident laser light thus increasing the length of time needed for the laser to deliver enough energy to inflict the desired damage to the target.

Another mechanism by which the coating improves survivability against such weapons is by blinding and/or dazzling the sensor(s) that are used by the laser weapon's adaptive optic system to focus the beam on the target and correct for atmospheric aberrations. This occurs because the retroreflective coatings reflect a portion of the laser weapon's beam back towards the source. This may result in any sensors close to the laser's emitter being illuminated enough to either blind or dazzle them. This interferes with the weapon's ability to maintain beam focus on the target and thus results in less effective transfer of beam energy to the target. This results in increasing the time necessary to inflict damage upon the target. Furthermore, the laser weapon may be damaged as a result of being irradiated by some portion of the reflected light from the beam.

These coatings also improve survivability against attack by weapons that utilize a laser-designated guidance system. In most of said weapons, the laser designator is physically separate from the deliverable weapon itself. For example, a ground-based laser designator supplying the illumination beam which guides an aerial bomb or missile to the target. Since the coatings constituting the present invention reflect a substantial portion of the incident laser light back towards the source, the reflected spot as seen by the sensors on the deliverable weapon itself is much dimmer than would be otherwise. This results in a shortening of the distance away from the target at which said sensors can detect the target. This reduces the time for the weapon to maneuver and decreases hit probability. For weapons that fly close to the designator beam path, the reflected beam may be intense enough to dazzle or blind the weapon's guidance sensors.

### BRIEF DESCRIPTION OF THE SEVERAL VIEWS OF THE DRAWING

The foregoing aspects and others will be readily appreciated by the skilled artisan from the following description of illustrative embodiments when read in conjunction with the accompanying drawings.

FIG. 1 illustrates a cross-sectional view of a retroreflective coating applied to a substrate.

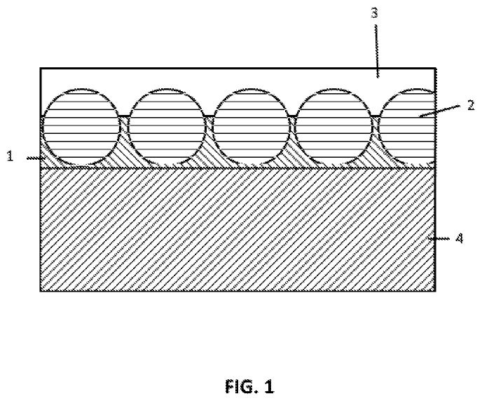

### DETAILED DESCRIPTION OF THE INVENTION

Before the invention is described in detail, it is to be understood that, unless otherwise indicated, this invention is not limited to particular embodiments, materials, and processes, as such may vary. It is also to be understood that the terminology used herein is for the purposes of describing particular embodiments only, and is not intended to be limiting.

As used in the specification and the appended claims, the singular forms “a,” “an,” and “the” include plural referents unless the context clearly indicates otherwise.

In this specification and the appended claims, reference will be made to a number of terms that shall be defined to have the following meanings:

The terms “optional” or “optionally” mean that the subsequently described feature or structure may or may not be present, or that the subsequently described event or circumstances may or may not occur, and that the description includes instances where a particular feature or structure is present and instances where it is not, or instances where the event or circumstance occurs and instances where it does not.

The term “dazzle” means to illuminate an optical sensor with enough light of an appropriate wavelength to render said sensor's output useless for its intended purpose.

The term “blind” means to illuminate an optical sensor with enough light of an appropriate wavelength to saturate or over saturate all of said sensor's light-detecting elements.

The term “target” means, depending on context, the projectile, vehicle, or structure intended for destruction by a weapon.

Before embarking on descriptions of particular embodiments of the present invention, it would be beneficial to review the design principles of the disclosure.

Laser-based directed energy weapons depend on their ability to transfer enough energy to a region on the target to cause it to weaken to the point of failure. To minimize both the time required to achieve said failure and to minimize the necessary beam power at a given range, the weapons normally utilizes adaptive optics to focus the beam as tightly as possible upon the target. These adaptive optics systems utilize sensors that, in conjunction with a laser, determine aberration from the atmosphere between the weapon and the target and adjust the adaptive optics to correct for this effect. This is critical to maintaining the focus on the target.

Said sensors used by the adaptive optics subsystem represent a vulnerability of the weapon system. Said sensors may be dazzled or blinded if they are illuminated with enough light. A mirrored surface placed perpendicular to the beam path of either the main laser of the weapon or a separate laser utilized by the adaptive optics subsystem may return enough light to the sensor to dazzle or blind it. However, in the field, this is not a practical defense due to many factors including lack of knowledge of from which direction and when such an attack may occur along with the fact that angles would be constantly changing due to relative motion between the target and weapon.

Since they reflect light back towards the source, though offset slightly, over a wide range of angles, retroreflectors provide a solution to this problem. Spherical retroreflectors half-coated with a metallic surface to improve reflection characteristics are well suited for this application. The metallic coating improves the reflection coefficient considerably which is an important factor because of the high power density of the incident light from laser weapons. This reduces considerably the energy from the weapons that would be absorbed by the retroreflectors. The metallic coating on the spheres also improves the scattering of said laser light when the sphere is aligned in a manner relative to the beam in which it is not acting as a retroreflector.

Another aspect of the present invention is that it can increase survivability against laser-designated and guided weapons. These weapon systems utilize a laser designator which illuminates the target with a laser beam. The laser light reflected by the target is detected by a sensor in the deliverable weapon and used to guide the weapon to the target. The present invention causes a significant portion of the incident laser light from the designator to be reflected back towards the designator. This reduces the brightness of the spot on the target as seen at an angle that departs from the illumination beam axis, with a decreasing brightness as said angular departure increases. Since, in most laser-designated weapon systems there exists such an angular difference between the illumination beam and the sensor on the deliverable weapon, for example missile or air-dropped bomb, the distance away from the illuminated target at which said sensor may detect the reflected laser light decreases accordingly. This may increase target survivability as the said reduction in sensing distance or range leads to a corresponding reduction in time and distance for the weapon to maneuver in order to obtain a hit.

Furthermore, in those laser-designated and guided weapon systems wherein the deliverable weapon, usually a missile, follows a trajectory close to the illumination beam axis, the laser light reflected by the present invention may be bright enough to dazzle or blind the sensors aboard the weapon. This also would significantly increase the survivability of the target.

Now turning to the preferred embodiments of the present invention.

The present invention consists of a layer 1 consisting of material acting as an adhesive to hold a multitude of spherical retroreflectors 2 to provide a coating of said retroreflectors on a substrate 4, such as the skin of an aerial vehicle or naval vessel. Said adhesive material should have a low absorption coefficient for the wavelength of laser light that is intended to be reflected. Said retroreflectors should be sized so that they are at minimum several times the diameter of the wavelength of the laser light that they are intended to reflect. This serves to increase the range of angles of incidence over which they act as retroreflectors. The retroreflectors should also be partially metallized, preferably half-coated with a metallic layer, to improve reflectiveness.

An optional layer 3 of a suitable material may be placed over the top of the retroreflector layer. This may be beneficial for encapsulating and holding in place said retroreflectors and may smooth the surface to reduce friction and to ease cleaning and maintenance of the coating. The material comprising this layer should possess a relatively high transmission coefficient for the wavelength of light the coating is intended to reflect.

A further layer may be added over this optional encapsulation layer to provide other desired surface properties. This layer should have a low absorption coefficient for the wavelength of laser light that is intended to be reflected by the coating.

It is sometimes advantageous to have paint on the surface of whatever object is to be coated, such as for marking and identification purposes. This should be applied on the substrate first. After said paint has dried or otherwise become fixed, the coating process may begin. Markings done in white paint still are visible, though subdued, after the coating was applied when 60 micron diameter glass retroreflectors half-coated with aluminum were used in a test sample.

The coating may be applied by spray coating the substrate with the adhesive material, or otherwise applying it, and then spraying or otherwise applying the retroreflectors on to the adhesive coated substrate or a suitable mixture of adhesive and retroreflectors may be sprayed or otherwise applied to the substrate. At a suitable time afterwards, an optional further layer as described before may be applied.

When applied as described the present invention can significantly improve the survivability of aircraft, drones, missiles, rockets, bombs, vehicles, surface naval vessels, and fixed structures against many laser-based or guided weapons.

I claim:

1) A method of reducing the amount of laser radiation absorbed by means of coating said body with a composition comprised of:
(a) a plurality of retroreflectors;
(b) wherein said retroreflectors are under one millimeter in diameter or along their greatest dimension;
(c) wherein said retroreflectors are bound to the surface of the body by means of an adhesive; and
(d) wherein the purpose of said retroreflective coating is to increase survivability of said body in a hostile environment.

2) The method of claim 1 wherein the survivability of the body is increased because of reduced energy transfer to said body upon irradiation by a laser weapon.

3) The method of claim 1 wherein the survivability of the body is increased because of dazzling of the sensors used to focus a laser weapon upon said body which results from laser radiation from said weapon being reflected back to said sensors because of the retroreflective coating on said body.

4) The method of claim 1 wherein the survivability of the body is increased because of a reduction in illumination spot brightness as observed by the sensors of a laser guided weapon approaching said body from a path off-axis from the illumination laser beam thereby decreasing the distance at which the illumination spot is detected by the sensors on said weapon and decreasing the ability for said weapon to adjust its course to said body.

5) The method of claim 1 wherein the retroreflectors are comprised of partially metallized glass spheres.

6) The method of claim 5 wherein the survivability of the body is increased because of reduced energy transfer to said body upon irradiation by a laser weapon.

7) The method of claim 5 wherein the survivability of the body is increased because of dazzling of the sensors used to focus a laser weapon upon said body which results from laser radiation from said weapon being reflected back to said sensors because of the retroreflective coating on said body.

8) The method of claim 5 wherein the survivability of the body is increased because of a reduction in illumination spot brightness as observed by the sensors of a laser guided weapon approaching said body from a path off-axis from the illumination laser beam thereby decreasing the distance at which the illumination spot is detected by the sensors on said weapon and decreasing the ability for said weapon to adjust its course to said body.

9) The method of claim 1 wherein the retroreflective coating is coated with an additional coating which smooths the exposed surface.

10) The method of claim 9 wherein the survivability of the body is increased because of reduced energy transfer to said body upon irradiation by a laser weapon.

11) The method of claim 9 wherein the survivability of the body is increased because of dazzling of the sensors used to focus a laser weapon upon said body which results from laser radiation from said weapon being reflected back to said sensors because of the retroreflective coating on said body.

12) The method of claim 9 wherein the survivability of the body is increased because of a reduction in illumination spot brightness as observed by the sensors of a laser guided weapon approaching said body from a path off-axis from the illumination laser beam thereby decreasing the distance at which the illumination spot is detected by the sensors on said weapon and decreasing the ability for said weapon to adjust its course to said body.

13) The method of claim 5 wherein the retroreflective coating is coated with an additional coating which smooths the exposed surface.

14) The method of claim 13 wherein the survivability of the body is increased because of reduced energy transfer to said body upon irradiation by a laser weapon.

15) The method of claim 13 wherein the survivability of the body is increased because of dazzling of the sensors used to focus a laser weapon upon said body which results from laser radiation from said weapon being reflected back to said sensors because of the retroreflective coating on said body.

16) The method of claim 13 wherein the survivability of the body is increased because of a reduction in illumination spot brightness as observed by the sensors of a laser guided weapon approaching said body from a path off-axis from the illumination laser beam thereby decreasing the distance at which the illumination spot is detected by the sensors on said weapon and decreasing the ability for said weapon to adjust its course to said body.
